(19) United States
(12) Patent Application Publication
(10) Pub. No.: US 2002/0056095 A1
(43) Pub. Date: May 9, 2002

(54) Digital video contents browsing apparatus and method

(76) Inventors: Yusuke Uehara, Kawasaki (JP); Daiki Masumoto, Kawasaki (JP); Naoki Sashida, Kawasaki (JP); Susumu Endo, Kawasaki (JP)

Correspondence Address: STAAS & HALSEY, Suite 500, 700 Eleventh Street, N.W., Washington, DC, 20001, US

(21) Appl. No.: 09/737,859

(22) Filed: Dec. 18, 2000

(30) Foreign Application Priority Data
Apr. 25, 2000 (JP) 2000-123605

(51) Int. Cl. G06F 3/00

(52) U.S. Cl. 725/38

(57) ABSTRACT

Video contents distributed by digital broadcasting are obtained and divided into video contents segments on a channel basis, a program basis, or a predetermined time basis. A collection of ions corresponding to the respective video contents segments can be displayed in accordance with a particular viewpoint when it is arranged in the position of the classification and arrangement results. The classification and arrangement are calculated according to the feature value of each video contents segment. Icons corresponding to the video contents segments are re-created by newly setting a division basis arbitrarily, the feature values of the video contents segments on the newly set division basis are extracted, and icons corresponding to video contents segments are rearranged for display.

### BACKGROUND OF THE INVENTION

1. Field of the Invention

The present invention relates to digital video contents browsing apparatus and method. According to the digital video contents browsing apparatus and method, in order to efficiently search for and reproduce a desired program, scene, or the like from a large amount of video contents distributed by ground wave broadcasting or satellite broadcasting in a digital form, cable broadcasting, or the like, based on the feature values (e.g., image features representing video contents, a text obtained from voice data, program data distributed accompanying the video contents, etc.), the video contents are classified and arranged for display in a two-dimensional or three-dimensional virtual space and browsed through, and the selected program, scene, or the like can be reproduced.

2. Description of the Related Art

Due to the recent rapid development of digital technology including a communication infrastructure, a number of digital broadcasting services having a multi-channel are being provided. In such digital broadcasting, it is not easy for a user to select a desired program or the like from a number of programs distributed on a number of channels. More specifically, since there are a large number of channels, a considerable amount of time is required merely for browsing through programs according to a conventional method (i.e., referring to a TV section in a newspaper, a magazine, or the like) in analog broadcasting. Furthermore, even according to a method for successively switching channels by using a TV receiver, a remote controller, or the like, a considerable amount of time and effort are required similarly.

In order to solve the above-mentioned problems, JP 10(1998)-215419 A or JP 11(1999)-196343 A discloses a method for newly creating a program table for selecting a station, based on an EPG (Electric Program Guide) composed of information (a broadcasting time, a program title, etc.) representing broadcasting contents on each channel, distributed accompanying video contents in digital broadcasting, thereby providing means for efficiently selecting a station.

However, according to the above-mentioned method using a program table, a broadcasting time and a program title described in program data are merely displayed, so that it is impossible to select a station while watching visual video contents.

Thus, JP 11(1999)-122555 A discloses a method using a navigation function that displays broadcasting contents on a plurality of channels as if the pages of a book are flipped through, with the use of three-dimensional CG technology.

However, according to the navigation function disclosed by JP 11(1999)-122555 A, it is required to successively confirm broadcasting contents on a number of channels. As a result, all the broadcasting contents should be confirmed; otherwise, it cannot be confirmed by a user which broadcasting contents are the ones the user wants to get. Therefore, in order to efficiently select a station from a number of channels, it is required that the broadcasting contents on each channel be browsed through simultaneously.

Furthermore, in an application of browsing through the recorded (stored) video contents of desired programs previously filtered with a keyword or the like, in addition to selection from a number of programs on the air, it is required that programs should be browsed through for selection on the basis of a scene in one program, as well as a channel (broadcasting station) or a program. According to the method disclosed by JP 11(1999)-122555A, all the scenes are required to be confirmed, which is inefficient.

Furthermore, it is required that, in addition to a broadcasting time and a program title described in program data, information representing video contents be classified and arranged for display on a screen, based on the standpoint of visual features of video contents, semantic features obtained by converting voice data into a text, and the like. It is also required that the standpoint for classification and arrangement be flexibly and rapidly switched.

### SUMMARY OF THE INVENTION

Therefore, with the foregoing in mind, it is an object of the present invention to provide digital video contents browsing apparatus and method, in which segments of video contents obtained by dividing digital video contents on a program basis, on a cut switch point basis, on a predetermined time basis, or the like are classified and arranged for display in a two-dimensional or three-dimensional space, based on visual feature values such as a color, semantic feature values obtained by converting voice data into a text, and the like; the feature values used for classification and arrangement are successively changed, if required; the results of reclassification and rearrangement are rapidly displayed; and a user browses through the results to play and display desired video contents, whereby digital video contents recorded in a large amount can be efficiently searched for and appreciated.

It is another object of the present invention to allow a desired program to be efficiently selected from a number of channels on the air by dealing with a plurality of digital video contents distributed on a number of channels in real time.

In order to achieve above-mentioned object, the digital video contents browsing apparatus of the present invention includes: a video contents obtaining part for obtaining video contents distributed by digital broadcasting; a feature value extracting part for extracting a plurality of feature values from the obtained video contents; a classification and arrangement part for classifying and arranging the video contents in a classification and arrangement space based on the feature values; an icon creating part for creating icons visually representing the video contents; a video contents dividing part for dividing the video contents into video contents segments on a channel basis, on a program basis, or on a predetermined time basis; and a classification and arrangement display part for displaying a collection of the icons corresponding to the video contents segments, in accordance with a viewpoint when the collection is placed at a position of classification and arrangement results obtained by the classification and arrangement part, wherein the video contents dividing part is capable of newly setting a division basis arbitrarily, the icon creating part re-creates the icons corresponding to the video contents segments, the feature value extracting part extracts feature values of the video contents segments on the newly set division basis, and the classification and arrangement display part rearranges the icons corresponding to the video contents segments for display.

Because of the above-mentioned structure, digital video contents recorded in a large amount can be dealt with as video contents segments obtained by dividing the video contents on a channel (broadcasting station) basis, on a program basis, or on a predetermined time basis. Each video contents segment is classified and arranged for display in a two-dimensional or three-dimensional space, based on the visual feature values and semantic feature values. Thus, a user can efficiently find a desired program, scene, or the like.

Furthermore, a user specifies an icon with respect to the classification and arrangement results in which icons (e.g., representative frame images) representing the contents of the respective contents segments, and plays and displays the contents of the corresponding video contents segment, whereby a user can rapidly appreciate the selected video contents segment.

Furthermore, in finding a desired scene or the like, it is also possible that a user classifies and arranges video contents segments on a genre or program basis for display and finds a desired program, and in order to browse through a detail of the contents of the program thus found, a user classifies and arranges video contents segments on a more detailed basis (e.g., on the basis of a scene contained in the found program, on a predetermined time basis, etc.).

Furthermore, it is preferable that the digital video contents browsing apparatus of the present invention further includes: a user profile management part for managing user profile information in which a procedure for allowing a user to select preferred contents from the video contents is described; a filtering part for selecting the video contents obtained by the video contents obtaining part, based on the procedure described in the user profile information; and a video contents storing part for storing the video contents selected by the filtering part. Because of this structure, video contents considered to be required by a user are automatically narrowed, whereby a search efficiency can be enhanced.

Furthermore, it is preferable that the digital video contents browsing apparatus of the present invention further includes a video playing part for specifying a particular icon in the collection of icons displayed by the classification and arrangement display part, thereby reproducing and displaying contents of the corresponding video contents segment at a position of the icon. Because of this structure, it can be rapidly determined whether or not the specified video contents are desired ones.

Furthermore, in the digital video contents browsing apparatus of the present invention, it is preferable that when the classification and arrangement part arranges the video contents segments in a two-dimensional classification and arrangement space defined by two axes, the classification and arrangement display part generates a frame image series of each of the video contents segments, as the icons representing contents of each of the video contents segments, and successively displays the icons represented as the frame image series in a depth direction of a screen. Because of this structure, merely looking at icons of frame image series makes it possible to know that the video contents segment has contents of a short period of time, which relieves a burden on calculation processing caused by play of animation.

Furthermore, in the digital video contents browsing apparatus of the present invention, it is preferable that the video playing part plays and displays the video contents segment corresponding to a specified icon at a position independent of a display of the classification and arrangement display part, and the specified icon is displayed with a highlight. According to this structure, play and display are conducted independently of icons in the classification and arrangement space, so that it becomes possible to browse through the played contents while simultaneously watching the classification are arrangement results and the played contents. Moreover, according to this structure, by displaying an icon in the classification and arrangement space with a highlight, a position of the video contents segment while it is being played in the classification and arrangement space is not lost.

Furthermore, in the digital video contents browsing apparatus of the present invention, it is preferable that the video playing part plays and displays not only the video contents segment corresponding to a specified icon, but also the video contents segment corresponding to another icon at a play speed in accordance with a distance of each icon with respect to the position of the specified icon in the classification and arrangement space. In the classification and arrangement space, video contents segments similar to the video contents segment which a user pays attention to are disposed in the vicinity thereof, and then, the similar video contents segments are played and displayed for browsing, simultaneously with the video contents segment which a user pays attention to.

However, when a plurality of video contents segments are played simultaneously at the same play speed, it is difficult to grasp the contents. In this case, if the video contents segment which a user pays attention to is played and displayed at an ordinary play speed, and the video contents segments in the vicinity thereof are played at a reduced speed (i.e., at a speed that is inversely proportional to the distance with respect to the video contents segment which a user pays attention to in the classification and arrangement space), it becomes easy to grasp the contents even when a plurality of video contents segments are simultaneously played. This utilizes visual characteristics in which an object can be seen most satisfactorily at an attention portion of human's eyes, and it becomes difficult to see an object at a position away from the attention portion.

Furthermore, in the digital video contents browsing apparatus of the present invention, it is preferable that the feature value of the video contents segment is a color ratio of each frame image contained in the video contents segment. The feature value of the video contents segment may be a dominant color that has a largest area among each frame image contained in the video contents segment. The feature value of the video contents segment may also be a luminance distribution pattern of pixels in each frame image data contained in the video contents segment.

Furthermore, it is preferable that the digital video contents browsing apparatus of the present invention has a character list display function of cutting out a face region of a person from each frame image contained in the video contents segment as a partial image, and arranging and displaying a collection of partial images of face regions as a character list in the video contents. Because of this structure, a user can find a program or a scene based on a character appearing therein, using a list of characters.

Furthermore, in the digital video contents browsing apparatus of the present invention, it is preferable that the classification and arrangement display part has a function of obtaining and displaying a web document represented by a URL (Universal Resource Locator) in program data accompanying the video contents segment through a WWW (World Wide Web) server. Because of this structure, by referring to information on the WWW server regarding the video contents, more video contents which a user is interested in can be grasped rapidly.

Furthermore, in the digital video contents browsing apparatus of the present invention, it is preferable that the video contents obtaining part simultaneously obtains video contents distributed from a plurality of broadcasting stations, and the plurality of video contents are displayed successively by the classification and arrangement display part without being stored in the video contents storing part. Because of this structure, video contents on the air distributed on a number of channels are classified and arranged for display in real time, which helps a user to select a station.

Furthermore, it is preferable that the classification and arrangement display part has a function of storing a screen image of display contents of classification and arrangement results or a function of printing the screen image of display contents of classification and arrangement results through a printing apparatus. According to this structure, when video contents are recorded in a DVD or the like, a screen image of display contents of classification and arrangement results is also stored; therefore, by displaying the screen image for confirmation of the contents later, the screen image can be utilized as an index for easily grasping the summary of the recorded contents. Furthermore, if the screen image of display contents of classification and arrangement results is printed as an index label, and the index label is attached to a case of a recording medium such as a DVD, the summary of the recorded contents can be easily grasped without displaying the contents by using a display apparatus.

Furthermore, the present invention is characterized by software that executes functions of the above-mentioned digital video contents browsing apparatus as processing operations of a computer. More specifically, the present invention is characterized by a digital video contents browsing method including the operations of: obtaining video contents distributed by digital broadcasting; extracting a plurality of feature values from the obtained video contents; classifying and arranging the video contents in a classification and arrangement space based on the feature values; creating icons visually representing the video contents; dividing the video contents into video contents segments on a channel basis, on a program basis, or on a predetermined time basis; and displaying a collection of the icons corresponding to the video contents segments in accordance with a particular viewpoint when the collection is placed in a position of the classification and arrangement results, wherein a division basis is allowed to be newly set arbitrarily, the icons corresponding to the video contents segments are recreated, feature values of the video contents segments on the newly set division basis are extracted, and icons corresponding to the video contents segments are rearranged for display, and a computer-readable recording medium storing the operations as a program.

Because of the above-mentioned structure, a digital video contents browsing apparatus can be realized, in which the above-mentioned program is loaded onto a computer and executed, whereby, in finding a desired scene or the like, it is possible that a user classifies and arranges video contents segments on a genre or program basis for display and finds a desired program, and in order to browse through a detail of the contents of the program thus found, a user classifies and arranges video contents segments on a more detailed basis (e.g., on the basis of a scene contained in the found program, on a predetermined time basis, etc.).

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram of a digital video contents browsing apparatus in Embodiment 1 according to the present invention.

FIG. 2 is a block diagram of a digital video contents browsing apparatus in an example according to the present invention.

FIG. 3 illustrates user profile information in the digital video contents browsing apparatus in Embodiment 1 according to the present invention.

FIG. 4 is a block diagram of a digital video contents browsing apparatus in another example according to the present invention.

FIGS. 5A and 5B illustrate exemplary divisions of video contents in the digital video contents browsing apparatus in Embodiment 1 according to the present invention.

FIG. 6A to 6C illustrate classification and arrangement spaces in the digital video contents browsing apparatus in Embodiment 1 according to the present invention.

FIG. 7 is a flow chart illustrating processing of storing video contents in the digital video contents browsing apparatus in Embodiment 1 according to the present invention.

FIG. 8 is a flow chart illustrating processing of browsing through video contents in the digital video contents browsing apparatus in Embodiment 1 according to the present invention.

FIG. 9 is a block diagram of a digital video contents browsing apparatus in Embodiment 2 according to the present invention.

FIG. 10 illustrates a specified user attention region in the digital video contents browsing apparatus in Embodiment 2 according to the present invention.

FIG. 11 is a flow chart illustrating processing in the digital video contents browsing apparatus in Embodiment 2 according to the present invention.

FIG. 12 is a block diagram of a digital video contents browsing apparatus in Embodiment 3 according to the present invention.

FIG. 13 illustrates a recording medium.

### DESCRIPTION OF THE PREFERRED EMBODIMENTS

Embodiment 1

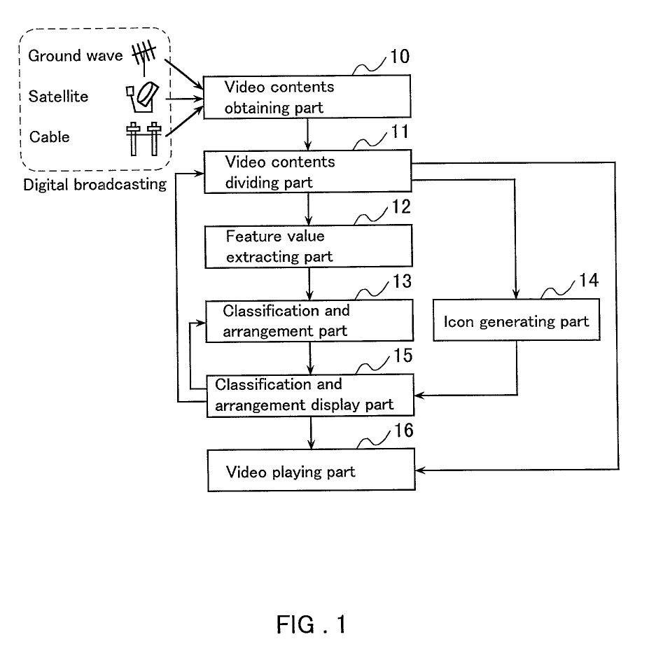

Hereinafter, a digital video contents browsing apparatus in Embodiment 1 according to the present invention will be described with reference to the drawings. FIG. 1 shows a block diagram of a digital video contents browsing apparatus in Embodiment 1 according to the present invention.

In FIG. 1, reference numeral 10 denotes a video contents obtaining part, which obtains video contents distributed by ground wave broadcasting or satellite broadcasting in a digital form, cable broadcasting, or the like.

Reference numeral 11 denotes a video contents dividing part, which divides the obtained video contents (time-series data) into video contents segments on a program basis, a cut switch point basis, a predetermined time basis, or the like.

Reference numeral 12 denotes a feature value extracting part, which extracts feature values representing the contents of each video contents segment obtained by the video contents dividing part 11. Herein, examples of the feature values include information representing the visual contents of a video contents segment, information representing the audio contents of a video contents segment, and information representing the semantic contents of a video contents segment.

Examples of the information representing the visual contents of a video contents segment include a color, a size, a moving direction, and the like of an object drawn in animation image data contained in a video contents segment; a color histogram (color ratio), a dominant color (having the largest area), and a color layout (color arrangement) of each frame image of animation image data contained in a video contents segment; a DCT conversion coefficient obtained by DCT conversion; a wavelet conversion coefficient obtained by wavelet conversion; and image information obtained by quantifying a texture feature that is a luminance distribution pattern of pixels.

Examples of the audio contents of a video contents segment include frequency characteristics and amplitude characteristics of voice data accompanying the video contents segment, and sound information obtained by quantifying time transition characteristics.

Examples of the information representing the semantic contents of a video contents segment include text information obtained by recognizing voice data accompanying the video contents segment as a voice, and text information representing a channel number, a program title, a genre name, and the like in program data distributed accompanying the video contents in digital broadcasting.

Next, reference numeral 13 denotes a classification and arrangement part, which sets an assignment to each axis of a classification and arrangement space, based on the feature values extracted by the feature value extracting part 12, and which classifies and arranges a collection of video contents segments in a classification and arrangement space. As a classification and arrangement space, a two-dimensional plane defined by two axes in an orthogonal system, a three-dimensional space defined by three axes, etc. are considered.

Furthermore, reference numeral 14 denotes an icon creating part, which generates and displays an icon image that visually represents the contents of a video contents segment. As an icon image, for example, a representative frame image of a video contents segment is considered; however, there is no particular limit as long as it is an image representing the contents of a video contents segment.

Reference numeral 15 denotes a classification and arrangement display part, which displays an icon corresponding to each video contents segment as an icon collection in accordance with a particular viewpoint on a display device such as a display, based on the classification and arrangement results obtained by the classification and arrangement part 13.

Reference numeral 16 denotes a video playing part, which specifies a particular icon in the icon collection displayed by the classification and arrangement display part 15, thereby playing and displaying the contents of the corresponding video contents segment at a display position of the specified icon. It should be noted that such play and display are not limited to a display position of the specified icon, and may be conducted in a separate display device or the like.

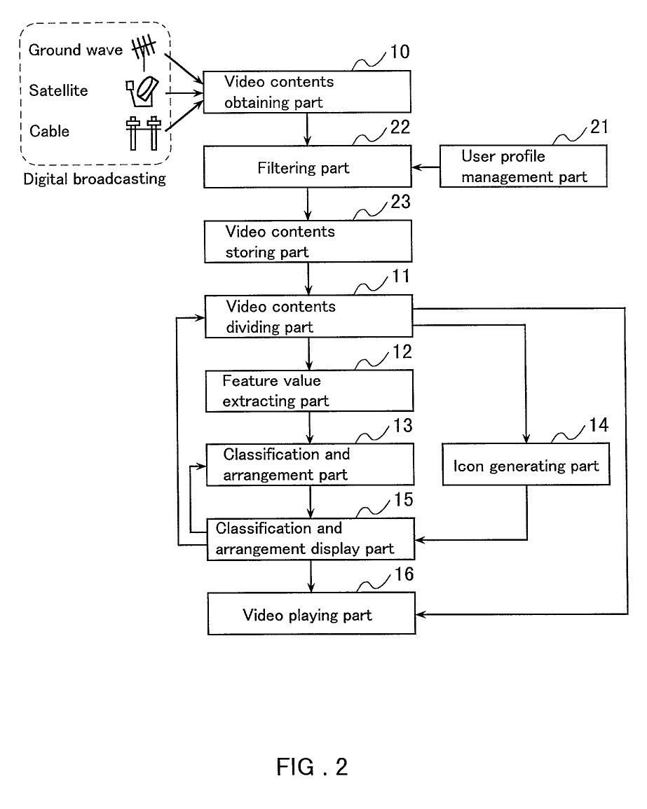

Actually, the digital video contents obtained by the video contents obtaining part 10 are so large that it is practical to adjust the amount of information to be handled by filtering the information to some degree. FIG. 2 shows a block diagram with such a function added thereto.

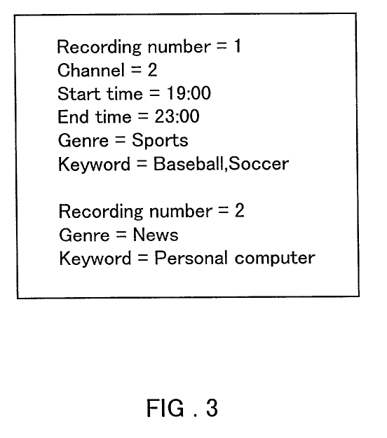

FIG. 2 is a block diagram of a digital video contents browsing apparatus in an example of the present invention. In FIG. 2, reference numeral 21 denotes a user profile management part, which manages user profile information used for selecting user's desired video contents from the video contents obtained by the video contents obtaining part 10. Herein, the user profile information refers to information for specifying video contents which a user wants to record, with reference to program data (a broadcasting time, a genre, a program title, etc.) distributed together with the video contents. The user profile information is a computer-readable information file describing a text, for example, as shown in FIG. 3.

An example shown in FIG. 3 describes that video contents are recorded, in which “Baseball” or “Soccer” is contained in program information among sports programs broadcast from 19:00 to 23:00 in a station on Channel “2”, and that video contents are recorded, in which “Personal computer” is contained in program information in a news program on an arbitrary channel at an arbitrary time. The form of user profile information, description items, description methods, and the like are not particularly limited to the example shown in FIG. 3.

Next, reference numeral 22 denotes a filtering part, which refers to the user profile information managed by the user profile management part 21 and selects video contents complying with the conditions specified by the user profile information from the video contents obtained by the video contents obtaining part 10.

Reference numeral 23 denotes a video contents storing part, which stores video contents selected by the filtering part 22. Based on the video contents stored in the video contents storing part 23, the processing similar to that shown in FIG. 1 is conducted.

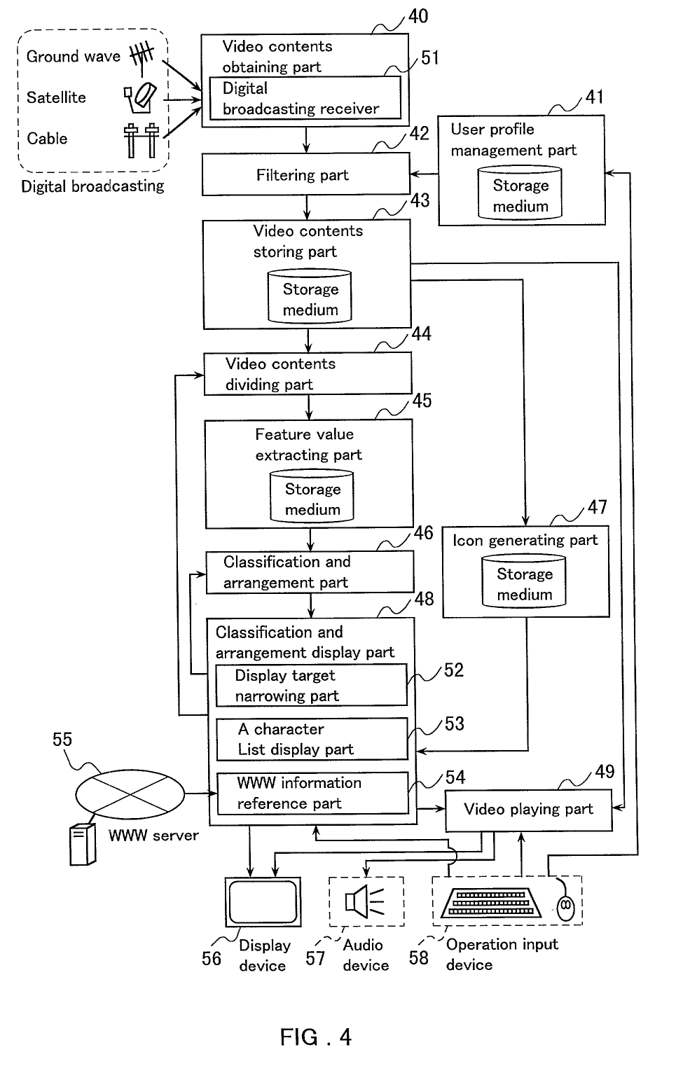

FIG. 4 shows a block diagram illustrating an actual structure. FIG. 4 is a block diagram showing a digital video contents browsing apparatus in another example of the present invention. Herein, video contents distributed by ground wave broadcasting or satellite broadcasting in a digital form, cable broadcasting, or the like are stored (recorded). Then, based on the feature values representing visual contents, audio contents, and semantic contents of the stored video contents, icons visually representing the respective video contents are classified and arranged for display in a two-dimensional or three-dimensional space. The video contents specified by a user with respect to display results are played and displayed, whereby a user can efficiently browse through and appreciates a large amount of video contents for the purpose of finding a desired program and scene.

In FIG. 4, reference numeral 40 denotes a video contents obtaining part, which obtains video contents distributed by ground wave broadcasting or satellite broadcasting in a digital form, cable broadcasting, or the like. The video contents obtaining part 40 is provided with a digital broadcasting receiver 51 for receiving digital broadcasting. The digital broadcasting receiver 51 functions as a tuner for ground wave broadcasting or satellite broadcasting in a digital form, cable broadcasting, or the like.

Reference numeral 41 denotes a user profile management part, which manages user profile information in which keywords, channel selection, and the like are described for a user to select preferable contents from the video contents obtained by the video contents obtaining part 40. The user profile information is, for example, a text information file as shown in FIG. 3, and stored in a storage medium provided in the user profile management part 41. As such a storage medium, a semiconductor memory and a magnetic storage apparatus are considered. However, the storage medium is not limited thereto, and any storage media can be used. Furthermore, a user can edit the user profile information, using an operation input device 58 such as a keyboard and a mouse.

Furthermore, reference numeral 42 denotes a filtering part, which compares program data obtained by the video contents obtaining part 40 together with the video contents, with the user profile information stored in a storage medium provided in the user profile management part 41, and selects video contents complying with the conditions described in the user profile information. For example, in the case where the user profile information has the contents shown in FIG. 3, under the condition of a recording number “1”, among the programs broadcast from 19:00 to 23:00 in a broadcasting station on channel “2”, a program is selected in which a text character string of the program data representing a genre matches with the character string “Sports” completely or partially, and a text character string representing a program title or program contents matches with the character string “Baseball” or “Soccer” completely or partially.

Next, reference numeral 43 denotes a video contents storing part, which stores video contents selected by the filtering part 42 in an internal storage medium. As the storage medium, a semiconductor memory and a magnetic storage apparatus are considered. However, the storage medium is not limited thereto. Any storage media can be used.

Furthermore, reference numeral 44 denotes a video contents dividing part, which divides the video contents that are time-series data (of a frame image) stored in the video contents storing part 43 on a time axis. Hereinafter, the segments obtained by dividing the video contents are referred to as “video contents segments”.

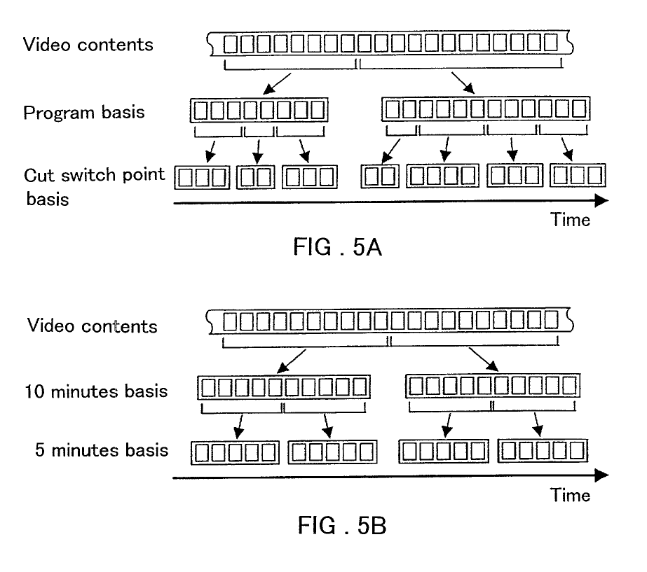

As shown in FIG. 5A, as a method for dividing video contents, division on a program basis and division on a cut switch point basis are considered. Furthermore, as another method, there is division on a predetermined time basis, as shown in FIG. 5B. Furthermore, as shown in FIGS. 5A and 5B, the video contents can also be divided by a method using a plurality of dividing methods hierarchically.

Reference numeral 45 denotes a feature value extracting part, which extracts the feature values representing the contents of each video contents segment obtained by the video contents dividing part 44. The extracted feature values are stored in a storage medium in the feature value extracting part 45.

Reference numeral 46 denotes a classification and arrangement part, which sets assignment to each axis in a classification and arrangement space, based on the feature values extracted by the feature value extracting part 45, and classifies and arranges a collection of the respective video contents segments in a classification and arrangement space defined by set axes.

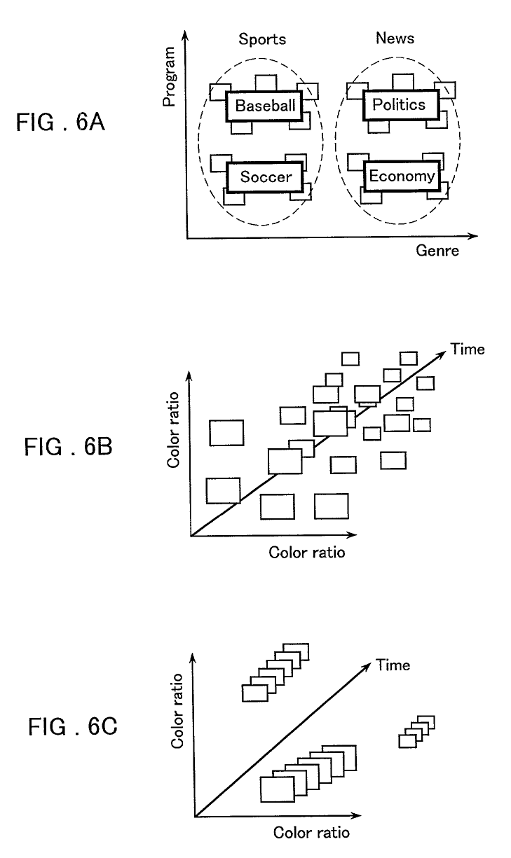

FIG. 6A schematically shows a two-dimensional classification and arrangement space in which the feature value “genre” is set on one axis (horizontal axis), and the feature value “program” is set on another axis (vertical axis). The feature value “genre” corresponds to a number when a number is assigned to each character string representing a genre in program data. The feature value “program” corresponds to each keyword character string number contained in a character string that represents a program title in the program data accompanying each video contents segment, when a number is assigned to each keyword character string for selecting a program in the user profile information.

Because of the above-mentioned axis setting, in FIG. 6A, groups are arranged in the horizontal axis direction on a genre basis, and groups of video contents segments are arranged on a program basis in the vertical axis direction with respect to the group in each genre.

FIG. 6B shows a schematic diagram of a three-dimensional classification and arrangement space, in which a color ratio feature value is set on the horizontal and vertical axes, and a time feature value is set on an axis in the depth direction. The feature value regarding a color ratio is a vector value obtained by quantifying a color ratio in a representative frame image of each video contents segment as a frequency vector. The time feature value corresponds to a broadcasting time of each video contents segment.

Due to such axis setting, as shown in FIG. 6B, video contents segments having a similar color ratio (i.e., having a small distance between vector values of color ratio feature values) are disposed close to each other on a plane defined by the horizontal axis and the vertical axis. Furthermore, video contents segments to be broadcast earlier are disposed frontward.

In this manner, one feature value can be set on a plurality of axes. Furthermore, although not shown in FIGS. 6A to 6C, assignment is also possible, in which the feature value and the axis have a multi-one or multi-multi relationship.

Furthermore, as a classification and arrangement method, as shown in FIG. 6A, a method for uniquely determining arrangement from the feature values is considered. When arrangement is conducted on a plane defined by the horizontal axis and the vertical axis, based on the similarity relationship of a color ratio, an arrangement position is calculated by using an algorithm of a Self-Organization Maps.

Reference numeral 47 denotes an icon creating part, which creates an icon image for displaying each video contents segment when displaying classification and arrangement results by the classification and arrangement part 46. As an icon image, for example, there is a representative frame image of a video contents segment. However, the icon image is not limited thereto. Any images may be used, as long as they represent the contents of the video contents segment.

Furthermore, as shown in FIG. 6C, in the case where an icon image is disposed in a three-dimensional space, it is also considered that an image to be a topic, as well as a leading frame, are generated in time series. Because of this, the video contents can be displayed in the order of time series by a user's instruction, and it can be easily determined whether or not the video contents are desired ones.

An icon image is stored in a storage medium provided in the icon creating part 47. As a storage medium, a semiconductor memory and a magnetic storage apparatus are considered. However, the storage medium is not limited thereto. Any storage media can be used.

Reference numeral 48 denotes a classification and arrangement display part, which displays, to a user through a display device 56 such as a CRT and a liquid crystal display, an icon collection in accordance with a particular viewpoint when the icons created by the icon creating part 47 are disposed at positions of the classification and arrangement results.

Furthermore, a user can change a viewpoint position by the operation input device 58 such as a keyboard and a mouse, and classification and arrangement results in accordance with a changed viewpoint are displayed. Furthermore, a user specifies a collection of particular video contents segments by the operation input device 58 with respect to a classification and arrangement results display, whereby the classification and arrangement part 46 reclassifies and rearranges only the specified collection of video contents segments, and the classification and arrangement display part 48 can display the reclassification and rearrangement results.

Furthermore, instead of that a user directly specifies a collection of video contents segments, the following is also possible. A user selects a collection of video contents segments to be classified and arranged for display under the conditions specified by a user, using the operation input device 58 with respect to the feature values extracted by the feature value extracting part 45, the collection of video contents segments selected by the classification and arrangement part 46 is reclassified and rearranged, and the reclassification and rearrangement results are displayed by the classification and arrangement display part 48. For example, regarding a text representing the contents in program data accompanying a video contents segment and a text obtained by recognizing voice data accompanying a video contents segment, only the video contents segments containing a keyword specified by a user can be targeted for classification and arrangement for display.

Furthermore, a user specifies new setting of assignment to each axis of a classification and arrangement space from the currently set feature values by the operation input device 58, whereby the classification and arrangement part 46 newly sets assignment to each axis of the classification and arrangement space, based on the feature values, and reclassifies and rearranges video contents segments, based on the newly set classification and arrangement space axis; as a result, reclassification and rearrangement results can be displayed by the classification and arrangement display part 48.

Furthermore, a user specifies a new division basis by altering the division basis of the current video contents, using the operation input device 58, whereby the video contents dividing part 44 divides video contents on an altered division basis, the feature value extracting part 45 extracts the feature values, the classification and arrangement part 46 reclassifies and rearranges video contents segments, and the classification and arrangement display part 48 can display the reclassification and rearrangement results.

It is also considered that the classification and arrangement display part 48 is provided with a character list display part 53 that cuts out a face region of each person from a frame image in the displayed video contents segment as a partial image and displays a list thereof. A user browse through a face image collection displayed in a character list, thereby efficiently finding a program or a scene where a particular person appears.

It is also considered that the classification and arrangement display part 48 is provided with a WWW information reference part 54 that, when the program data accompanying the video contents contains a URL of a web document describing program contents, is connected to a WWW server to obtain a web document indicated by the URL of program data and displays it. A user specifies a particular video contents segment, using the operation input device 58, whereby the user can read the related web document displayed by the WWW information reference part 54 and know the contents of the specified video contents segment in more detail.

Reference numeral 49 denotes a video playing part, which specifies a particular icon in the icon collection displayed by the classification and arrangement display part 48, thereby playing and displaying the contents of the corresponding video contents segment at a position of the specified icon through the display device 56. Furthermore, voice (audio) data corresponding to the video contents segment can be played through an audio device 57 such as a speaker.

A user can play and appreciate a desired video contents segment by using the operation input device 58. The video contents segment is played, for example, when a displayed icon is clicked on by a mouse or the like, or when a pointer is overlapped with an icon for at least a predetermined period of time.

It is also considered that the specified video contents segment, and the video contents segment close to the specified video contents segment are simultaneously played. In this case, in a classification and arrangement space, it is preferable that the video contents segment having a distance D from the specified video contents segment is played at a speed S calculated by the following equation. Herein, in Equation 1, S₀ represents a play speed of the specified video contents segment, and α represents a coefficient.

S=α·S₀/D² (1)

According to this method, the video contents segment in the vicinity of the specified video contents segment is played at a speed that is inversely proportional to the square of a distance from the specified video contents segment. Because of this, it becomes possible to easily confirm what kind of video contents are present in the vicinity of the specified video contents segment, without impairing the visibility of the specified video contents segment. Furthermore, a user can also walk through the video contents segments, while changing the viewpoint on a classification and arrangement space, simultaneously with the play of the specified video contents segment.

The video contents segment may be played on a classification and arrangement space display, or played in a region independent of the classification and arrangement space display. In the case where the video contents segment is played in a region independent of the classification and arrangement space display, it is preferable to display, in the classification and arrangement space display, the icon corresponding to the video contents segment specified for play with a highlight by adding a red frame, so that the position of the video contents segment is not lost while it is being played. A display method with a highlight is not particularly limited thereto, and a method for adding a frame of another color or a method for flashing an icon may be used.

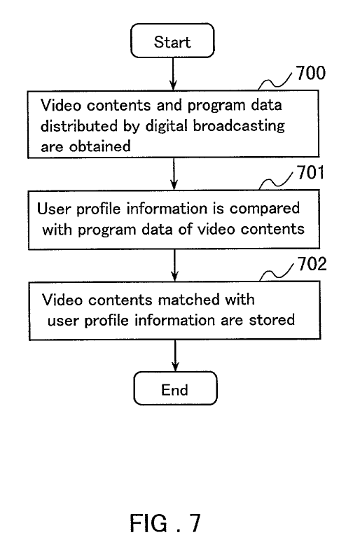

Next, FIG. 7 shows a flow chart illustrating processing of storing video contents in a digital video contents browsing apparatus in Embodiment 1 of the present invention. In FIG. 7, video contents distributed by digital broadcasting and program data accompanying the video contents are obtained by a video contents obtaining part 40 via a digital broadcasting receiver (Operation 700). The obtained program data is compared with the user profile information stored in the user profile storing part 41 by the filtering part 42 (Operation 701). The video contents having program data that complies with the conditions described in the user profile information are stored in a storage medium by the video contents storing part 43 (Operation 702).

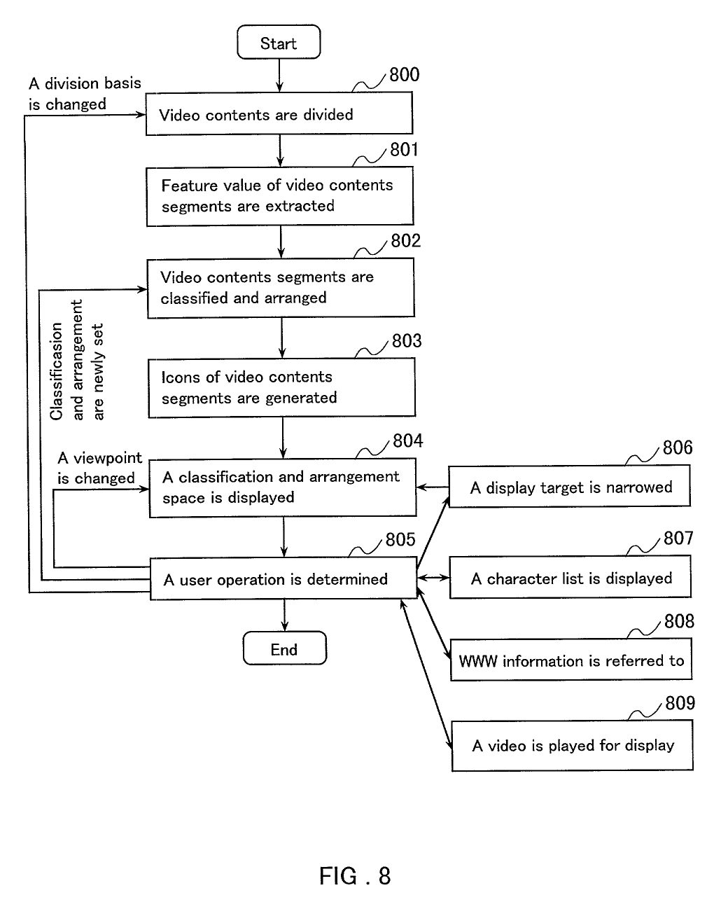

FIG. 8 shows a flow chart illustrating processing of browsing in the digital video contents browsing apparatus in Embodiment 1 of the present invention. In FIG. 8, the video contents stored in the video contents storing part 43 is divided into video contents segments by the video contents storing part 44 (Operation 800). Then, the feature value extracting part 45 extracts the feature values for each video contents segment (Operation 801).

The classification and arrangement part 46 sets the feature values assigned to each axis in a classification and arrangement space, and based on the set feature values, the video contents segments are arranged in a classification and arrangement space (Operation 802). On the other hand, the icon creating part 47 creates an icon for displaying each video contents segment thus arranged (Operation 803).

The classification and arrangement display part 48 displays the classification and arrangement results from a predetermined viewpoint on the display device 56 by displaying a generated icon (Operation 804). A user inputs an operation with respect to the contents of the classification and arrangement space display by using the operation input device 58, and the classification and arrangement display part 48 determines the contents of the operation (Operation 805).

In the case where the content of the operation is to change a viewpoint position, the operations after Operation 804 are repeated with respect to the specified viewpoint position. In the case where the content of the operation is to newly set the classification and arrangement space axes, the operations after Operation 802 are repeated with respect to the newly set axis. In the case where the content of the operation is to newly set a division basis of the video contents, the operations after Operation 800 are repeated with respect to the newly set division basis.

Furthermore, in the case where the content of the operation is to narrow the currently displayed collection of video contents segments, the classification and arrangement display part 48 narrows the display target based on the conditions given by a user through the operation input device 58, and thereafter, the operations after Operation 804 are repeated (Operation 806).

In the case where the content of the operation is to display a character list, the classification and arrangement display part 48 cuts out a face region from a frame image in the currently displayed video contents segment as a partial image, a list of face region partial images is displayed, and the operations after Operation 805 are repeated (Operation 807).

In the case where the content of the operation is to display a related web document of the video contents segment, the classification and arrangement display part 48 gets access to a WWW server to display a web document, with respect to the video contents segment specified by a user through the operation input device 58, and the operations after Operation 805 are repeated (Operation 808).

In the case where the content of the operation is to play a video contents segment, the video playing part 49 plays and displays the video contents segment specified by a user through the operation input device 58 in accordance with a play method specified by a user through the operation input device 58, and the operations after Operation 805 are repeated (Operation 809). In the case where the content of the operation is to end browsing, the processing is ended.

As described above, in Embodiment 1, video contents distributed by ground wave broadcasting or satellite broadcasting in a digital form, cable broadcasting, or the like are stored (recorded). Then, based on the feature values representing visual contents, audio contents, and semantic contents of the stored video contents, icons visually representing the respective video contents are classified and arranged in a two-dimensional or three-dimensional space. The video contents specified by a user with respect to display results are played and displayed, whereby a user can efficiently browse through and appreciate a large amount of video contents for the purpose of finding a desired program and scene.

Embodiment 2

A digital video contents browsing apparatus in Embodiment 2 of the present invention will be described. The object of the digital video contents browsing apparatus in Embodiment 2 is that video contents regarding a number of digital broadcasting programs (channels) that are being broadcast by a plurality of broadcasting stations are dynamically classified and arranged for play in a two-dimensional or three-dimensional space on a channel basis, based on the feature values representing the visual contents, audio contents, and semantic contents, whereby a user's desired program can be efficiently selected.

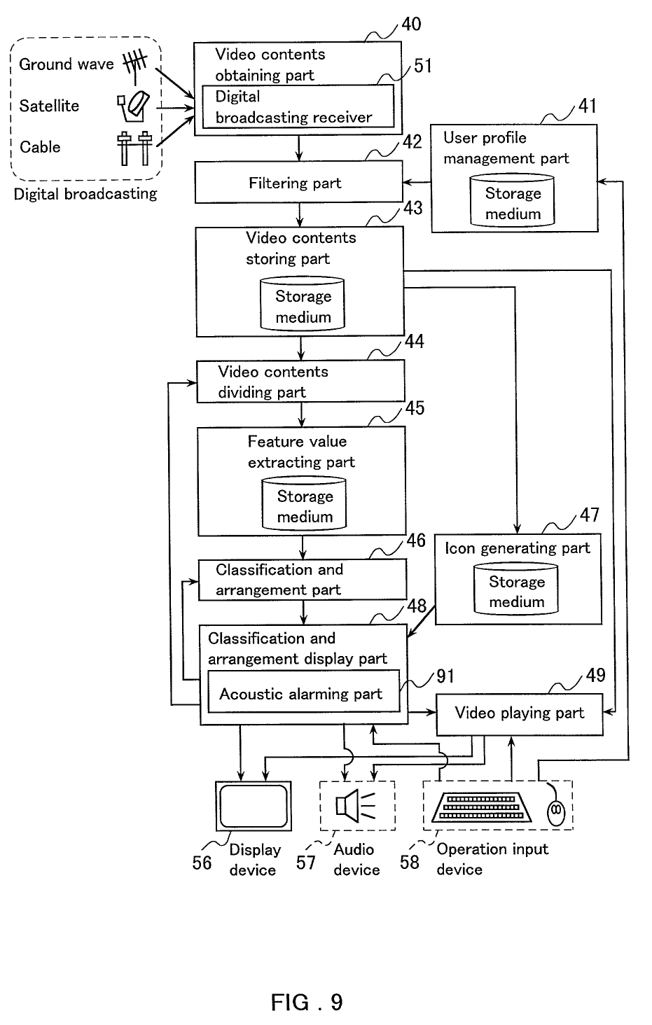

FIG. 9 shows a structure of a digital video contents browsing apparatus in Embodiment 2 of the present invention. In FIG. 9, reference numeral 40 denotes a video contents obtaining part, which simultaneously obtains video contents distributed by a plurality of broadcasting stations through ground wave broadcasting or satellite broadcasting in a digital form, cable broadcasting, or the like. Reference numeral 41 denotes a user profile management part, which stores user profile information describing the conditions for a user to select a desired program. Reference numeral 42 denotes a filtering part, which compares the program data accompanying the video contents obtained by the video content obtaining part 40 with the user profile information stored in the user profile management part 41, and selects a target channel (program). It is also possible that the filtering part 42 does not select a channel; in this case, all the receivable channels are targeted.

Reference numeral 43 denotes a video contents storing part, which temporarily stores a channel selected by the filtering part 42 or video contents on all the receivable channels. As a storage medium, a high-speed accessible semiconductor memory and the like are preferable.

Reference numeral 44 denotes a video contents dividing part, which divides video contents of each channel temporarily stored in the video contents storing part 43 on a predetermined time basis. Reference numeral 45 denotes a feature value extracting part, which extracts visual feature values, audio feature values, and semantic feature values from a video contents segment of each channel on a predetermined time basis obtained by the video contents dividing part 44.

Reference numeral 46 denotes a classification and arrangement part, which sets assignment to each axis in a classification and arrangement space, based on the feature values extracted by the feature value extracting part 45, and classifies and arranges the video contents segments of each channel in the classification and arrangement space, based on the feature values of the video contents segments of each channel.

Reference numeral 47 denotes an icon creating part, which creates an icon image for visually displaying each video contents segment. Reference numeral 48 denotes a classification and arrangement display part, which displays, to a user through a display device, an icon collection in accordance with a particular viewpoint when icons corresponding to the video contents segments of each channel are disposed at positions of the classification and arrangement results by the classification and arrangement part 46.

The classification and arrangement display part 48 automatically displays the contents of the classification and arrangement results changed at a time when the classification and arrangement results are changed. This is conducted in accordance with that the video contents obtaining part 40 successively obtains video contents of each channel, and the video contents dividing part 44 divides the video contents on a predetermined time basis to successively generate video contents segments, whereby a collection of the target video contents segments are successively (on a predetermined time basis) changed. A user browses through the classification and arrangement results in accordance with the program contents of each channel that vary with time, thereby efficiently selecting a desired program from a number of channels on the air.

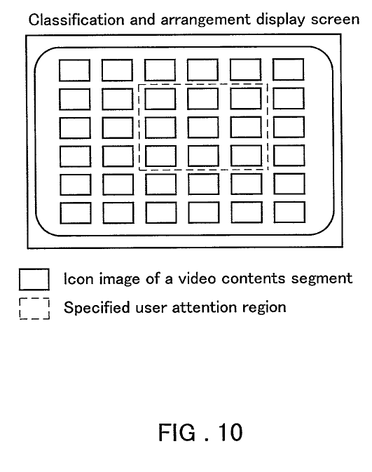

Furthermore, as shown in FIG. 10, it is also possible that only the video contents of a channel classified and arranged in a particular attention region specified by a user through the operation input device 58 are targeted for display. In an example of FIG. 10, among the video contents classified and arranged in a two-dimensional space, video contents to be displayed are supported by a drag operation using a mouse or the like, whereby a collection of the target video segments can be successively changed, and a channel to be displayed is also automatically changed in accordance with such a change.

The following is also considered. Regarding a particular attention region specified by a user through the operation input device 58 as shown in FIG. 10, when a video contents segment of a new channel appears in the specified region, in accordance with the successive change in the collection of target video segments, or when a video contents segment of a channel that has been displayed in the specified region disappears therefrom, an acoustic alarming part 91 provided in the classification and arrangement display part 48 acoustically informs a user of the above-mentioned matter through the audio device 57 such as a speaker. Because of this, if a region in a classification and arrangement display corresponding to a desired program is previously specified, a user is acoustically informed when a program to be arranged in the specified region appears, or when the program having been arranged in the specified region disappears, and a user will know the beginning and end of the desired program without continuing to watch the classification and arrangement display.

Reference numeral 49 denotes a video playing part, which specifies a particular icon in an icon collection displayed by the classification and arrangement display part 48, and plays and displays the contents of the corresponding video contents segment in a position of the specified icon in the display device 56. Furthermore, in the case where a channel is selected in real time, video contents segments of all the channels displayed by the classification and arrangement display part 48 are continuously played and displayed at a position of the corresponding icon. Furthermore, voice (audio) data accompanying the video contents segment is also played by the audio device 57.

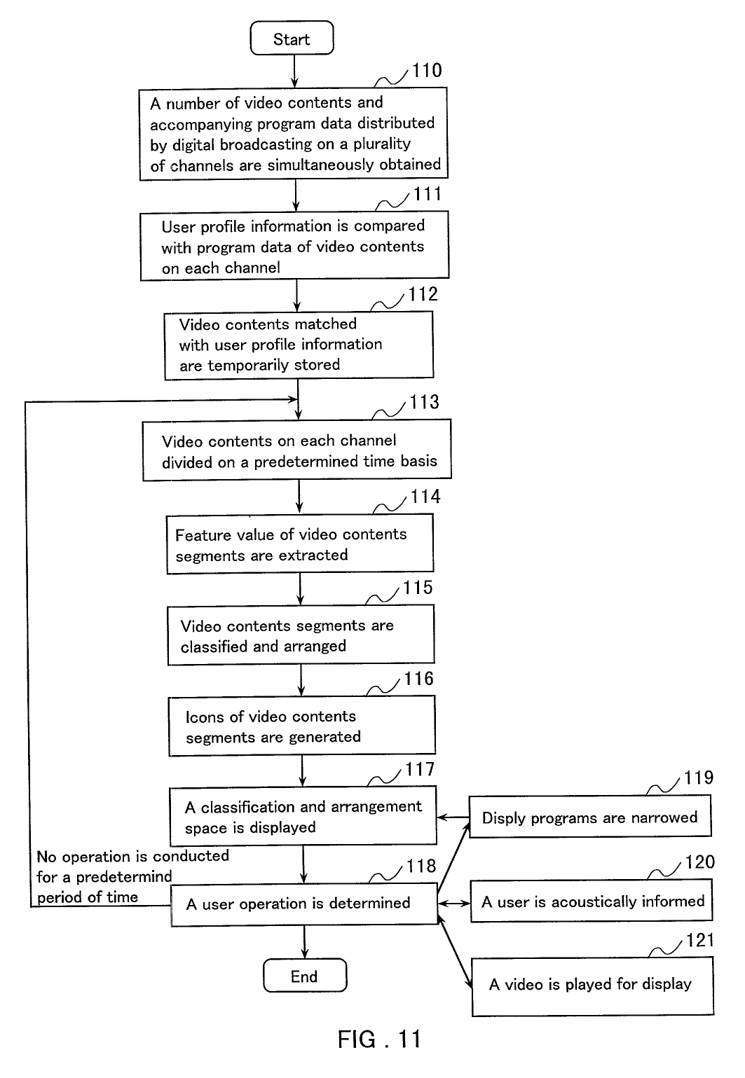

FIG. 11 shows a flow chart illustrating processing of digital video contents browsing apparatus in Embodiment 2 of the present invention. A number of video contents and accompanying program data distributed by digital broadcasting in a plurality of broadcasting stations is obtained by the video contents obtaining part 40 (Operation 110). The filtering part 42 compares the program data of each channel thus obtained with the user profile information stored in the user profile management part 41 (Operation 111). Video contents of a channel having program data that complies with the conditions described in the user profile information are temporarily stored in a storage medium by the video contents storing part 43 (Operation 112).

The video contents dividing part 44 divides video contents of each channel stored in the video contents storing part 43 into video contents segments (Operation 113). The feature value extracting part 45 extracts the feature values with respect to each video contents segment (Operation 114).

Then, the classification and arrangement part 46 sets the feature values to be assigned to each axis in a classification and arrangement space, and arranges the video contents segments in the classification and arrangement space (Operation 115). On the other hand, the icon creating part 47 creates an icon for displaying each video contents segment (Operation 116).

The classification and arrangement display part 48 displays the classification and arrangement results from a particular viewpoint to a user by displaying the generated icon in the display device 56 (Operation 117). A user inputs an operation with respect to the contents of the classification and arrangement display through the operation input device 58, and the classification and arrangement display part 48 determines the content of the operation (Operation 118).

In the case where the content of the operation is to narrow the collection of programs (video contents segments) by specifying a particular region on a classification and arrangement space display as shown in FIG. 10, the classification and arrangement display part 48 narrows display targets to video contents segments arranged in the specified display region, and the operations after Operation 117 are repeated (Operation 119).

In the case where the content of the operation is to drive the acoustic alarm function by specifying a particular region on a classification and arrangement space display as shown in FIG. 10, when a video contents segment is newly arranged in the specified region or when a video contents segment arranged in the specified region disappears, the classification and arrangement display part 48 acoustically informs a user of the above matter, and the operations after Operation 118 are repeated (Operation 120).

In the case where the content of the operation is to continuously play video contents segments that are being displayed, the video contents segment of each channel corresponding to the position of each icon is played and displayed at the position of each icon, and the operations after Operation 118 are repeated (Operation 121).

Furthermore, in the case where a user's operation has not been conducted for a predetermined period of time (e.g., a short period of time (about 1 millisecond)), the operations after Operation 113 are repeated. In the case where the content of the operation is to end processing, the processing is ended.

As described above, in Embodiment 2, video contents on a number of digital broadcasting programs (channels) that are broadcast by a plurality of broadcasting stations are dynamically classified and arranged for play in a two-dimensional or three-dimensional space, based on the feature values representing the visual contents, audio contents, and semantic contents on a channel basis, whereby a user's desired program can be efficiently selected.

Embodiment 3

Next, a digital video contents browsing apparatus in Embodiment 3 of the present invention will be described. The object of the digital video contents browsing apparatus in Embodiment 3 is that digital video contents obtained from the WWW server on the Internet, digital video contents recorded in a digital movie, and digital video contents obtained by encoding video data recorded in an analog movie in a digital form, as well as the video contents distributed by digital broadcasting are classified and arranged for play in a two-dimensional or three-dimensional space, based on the feature values representing the visual contents, audio contents, and semantic contents of the video contents, whereby a user can efficiently browse through and appreciate a large amount of digital video contents.

Another object of the digital video contents browsing apparatus in Embodiment 3 is that image data representing display contents of the classification and arrangement results are stored as an image index of the recorded contents, together with the classified and arranged video contents collection, whereby a user can grasp the summary of the recorded video contents collection merely by displaying an image index without conducting processing such as classification and arrangement for later browsing. Still another object of the digital video contents browsing apparatus in Embodiment 3 is that a collection of video contents is allowed to be stored in an external storage medium such as a DVD-RAM and a digital video tape, and an image index is printed so as to be attached to an external storage medium, whereby a user can grab the summary of a collection of video contents stored in the storage medium without confirming by the use of a digital video contents browsing apparatus of the present invention, or another reproducing apparatus.

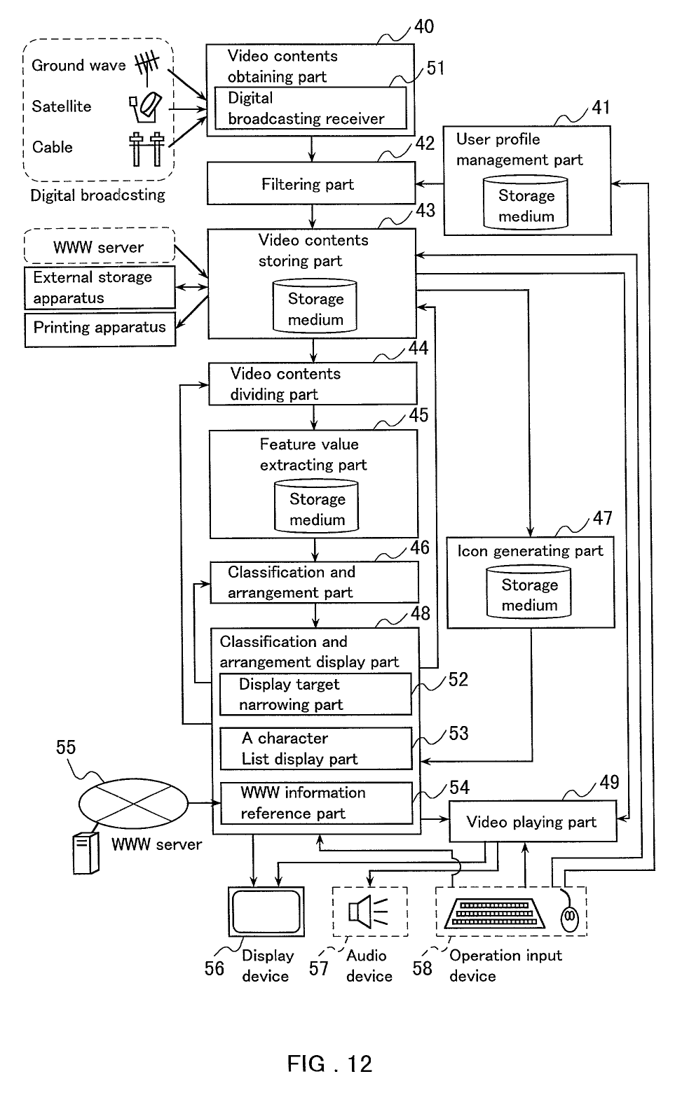

FIG. 12 is a block diagram of a digital video contents browsing apparatus in Embodiment 3 of the present invention. In FIG. 12, reference numeral 43 denotes a video contents storing part, which obtains digital video contents on the WWW server, digital video contents stored in a storage medium such as a DVD, a digital video tape, and an external hard disk, digital video contents recorded in a digital movie, or digital video contents obtained by encoding video data recorded in an analog movie in a digital form, as well as video contents of digital broadcasting obtained by a video contents obtaining part 40, and stores them in an internal storage medium.

A classification and arrangement display part 48 generates a display image of the classification and arrangement results as an image index, when a user specifies storage of the classification and arrangement results of a video contents segment that is being displayed. The video contents storing part 43 stores the image index generated by the classification and arrangement display part 48 in an internal storage medium or an external storage apparatus, together with the video contents collection that is being displayed.

Furthermore, the video contents storing part 43 prints the image index generated by the classification and arrangement display part 48 through a printing apparatus such as a color printer, when a user specifies printing of the image index. For example, it is possible that an image index obtained by classifying and arranging the video contents stored in a DVD is printed on a label, and attached to a case of a DVD medium as an image index. The other constituent parts are similar to those in Embodiment 1.

As described above, in Embodiment 3, the kind of video contents to be browsed through in the digital video contents browsing apparatus of the present invention is increased, and the summary of a collection of video contents can be easily grasped.

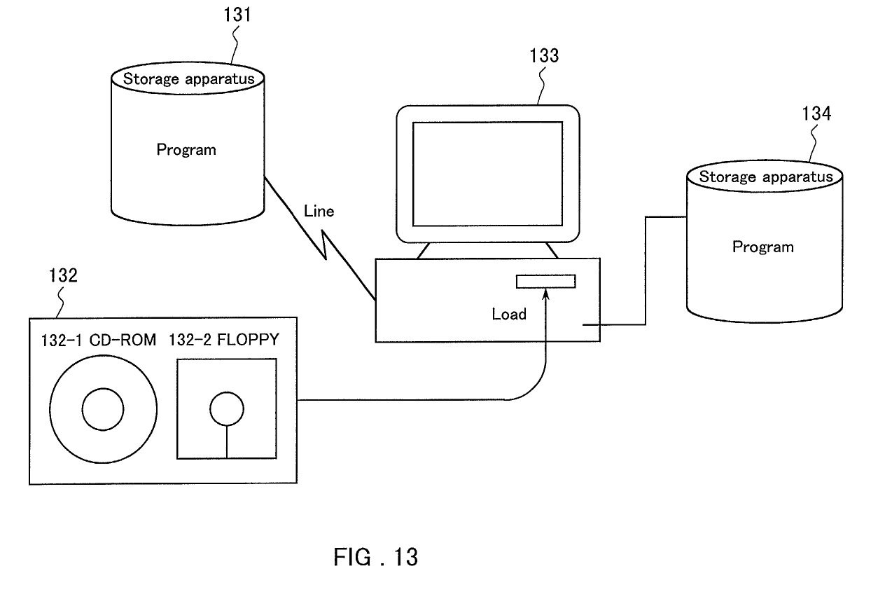

Examples of a recording medium recording a program that realizes the digital video contents browsing apparatus in the embodiment according to the present invention include a storage apparatus 131 provided at the end of a communication line and a recording medium 134 such as a hard disk and a RAM of a computer 133, as well as a portable recording medium 132 such as a CD-ROM 132-1 and a floppy disk 132-2, as illustrated in an example of a recording medium shown in FIG. 13. In execution, the program is loaded and executed on a main memory.

Furthermore, examples of a recording medium recording video contents data and the like generated by the digital video contents browsing apparatus in the embodiment according to the present invention include a storage apparatus 131 provided at the end of a communication line and a recording medium 134 such as a hard disk and a RAM of a computer 133, as well as a portable recording medium 132 such as a CD-ROM 132-1 and a floppy disk 132-2, as shown in FIG. 13. For example, the recording medium is read by a computer 133 when the digital video contents browsing apparatus of the present invention is utilized.

As described above, according to the digital video contents browsing apparatus of the present invention, video contents distributed by ground wave broadcasting or satellite broadcasting in a digital form, cable broadcasting, or the like are stored (recorded). Then, based on the feature values representing visual contents, audio contents, and semantic contents of the stored video contents, icons visually representing the respective video contents are classified and arranged in a two-dimensional or three-dimensional space. The video contents specified by a user with respect to the display results are played and displayed, whereby a user can efficiently browse through and appreciate a large amount of video contents for the purpose of finding a desired program and scene.

Furthermore, video contents regarding a number of digital broadcasting programs (channels) that are being broadcast by a plurality of broadcasting stations are dynamically classified and arranged for play in a two-dimensional or three-dimensional space, based on the feature values representing the visual contents, audio contents, and semantic contents on a channel basis, whereby a user's desired program can be efficiently selected.

Furthermore, digital video contents obtained from the WWW server on the Internet, digital video contents recorded in a digital movie, and digital video contents obtained by encoding video data recorded in an analog movie in a digital form, as well as the video contents distributed by digital broadcasting are classified and arranged for play in a two-dimensional or three-dimensional space, based on the feature values representing the visual contents, audio contents, and semantic contents of the video contents, whereby a user can efficiently browse through and appreciate a large amount of digital video contents.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A digital video contents browsing apparatus, comprising:
a video contents obtaining part for obtaining video contents distributed by digital broadcasting;
a feature value extracting part for extracting a plurality of feature values from the obtained video contents;
a classification and arrangement part for classifying and arranging the video contents in a classification and arrangement space based on the feature values;
an icon creating part for creating icons visually representing the video contents;
a video contents dividing part for dividing the video contents into video contents segments on a channel basis, on a program basis, or on a predetermined time basis; and
a classification and arrangement display part for displaying a collection of the icons corresponding to the video contents segments, in accordance with a viewpoint when the collection is placed at a position of classification and arrangement results obtained by the classification and arrangement part,
wherein the video contents dividing part is capable of newly setting a division basis arbitrarily, the icon creating part re-creates the icons corresponding to the video contents segments, the feature value extracting part extracts feature values of the video contents segments on the newly set division basis, and the classification and arrangement display part rearranges the icons corresponding to the video contents segments for display.

2. A digital video contents browsing apparatus according to claim 1, further comprising:
a user profile management part for managing user profile information in which a procedure for allowing a user to select preferred contents from the video contents is described;
a filtering part for selecting the video contents obtained by the video contents obtaining part, based on the procedure descried in the user profile information; and
a video contents storing part for storing the video contents selected by the filtering part.

3. A digital video contents browsing apparatus according to claim 1, further comprising a video playing part for specifying a particular icon in the collection of icons displayed by the classification and arrangement display part, thereby playing and displaying contents of the corresponding video contents segment at a position of the icon.

4. A digital video contents browsing apparatus according to claim 1, wherein, when the classification and arrangement part arranges the video contents segments in a two-dimensional classification and arrangement space defined by two axes, the classification and arrangement display part generates a frame image series of each of the video contents segments, as the icons representing contents of each of the video contents segments, and successively displays the icons represented as the frame image series in a depth direction of a screen.

5. A digital video contents browsing apparatus according to claim 1, wherein the video playing part plays and displays the video contents segment corresponding to a specified icon at a position independent of a display of the classification and arrangement display part, and the specified icon is displayed with a highlight.

6. A digital video contents browsing apparatus according to claim 1, wherein the video playing part plays and displays not only the video contents segment corresponding to a specified icon, but also the video contents segment corresponding to another icon at a play speed in accordance with a distance of each icon with respect to the position of the specified icon in the classification and arrangement space.

7. A digital video contents browsing apparatus according to claim 1, wherein the feature value of the video contents segment is a color ratio of each frame image contained in the video contents segment.

8. A digital video contents browsing apparatus according to claim 1, wherein the feature value of the video contents segment is a dominant color that has a largest area among each frame image contained in the video contents segment.

9. A digital video contents browsing apparatus according to claim 1, wherein the feature value of the video contents segment is a luminance distribution pattern of pixels in each frame image data contained in the video contents segment.

10. A digital video contents browsing apparatus according to claim 1, wherein the classification and arrangement display part has a character list display function of cutting out a face region of a person from each frame image contained in the video contents segment as a partial image, and arranging and displaying a collection of partial images of face regions as a character list in the video contents.

11. A digital video contents browsing apparatus according to claim 1, wherein the classification and arrangement display part has a function of obtaining and displaying a web document represented by a URL (Universal Resource Locator) in program data accompanying the video contents segment through a WWW (World Wide Web) server.

12. A digital video contents browsing apparatus according to claim 1, wherein the video contents obtaining part simultaneously obtains video contents distributed from a plurality of broadcasting stations, and the plurality of video contents are displayed successively by the classification and arrangement display part without being stored in the video contents storing part.

13. A digital video contents browsing apparatus according to claim 1, wherein the classification and arrangement display part has a function of storing a screen image of display contents of classification and arrangement results or a function of printing the screen image of display contents of classification and arrangement results through a printing apparatus.

14. A digital video contents browsing method, comprising the operations of:
obtaining video contents distributed by digital broadcasting;
extracting a plurality of feature values from the obtained video contents;
classifying and arranging the video contents in a classification and arrangement space based on the feature values;
creating icons visually representing the video contents;
dividing the video contents into video contents segments on a channel basis, on a program basis, or on a predetermined time basis; and
displaying a collection of the icons corresponding to the video contents segments in accordance with a particular viewpoint when the collection is placed in a position of the classification and arrangement results,
wherein a division basis is allowed to be newly set arbitrarily, the icons corresponding to the video contents segments are re-created, feature values of the video contents segments on the newly set division basis are extracted, and icons corresponding to the video contents segments are rearranged for display.

15. A computer-readable recording medium storing a program to be executed by a computer for realizing a digital video contents browsing method, the method comprising the operations of:
obtaining video contents distributed by digital broadcasting;
extracting a plurality of feature values from the obtained video contents;
classifying and arranging the video contents in a classification and arrangement space based on the feature values;
creating icons visually representing the video contents;
dividing the video contents into video contents segments on a channel basis, on a program basis, or on a predetermined time basis; and
displaying a collection of the icons corresponding to video contents segments in accordance with a particular viewpoint when the collection is placed at a position of the classification and arrangement results,
wherein a division basis is allowed to be newly set arbitrarily, the icons corresponding to the video contents segments are re-created, feature values of the video contents segments on the newly set division basis are extracted, and the icons corresponding to the video contents segments are rearranged for display.
